(19) United States
(12) Patent Application Publication
(10) Pub. No.: US 2026/0254669 A1
(43) Pub. Date: Aug. 27, 2026

(54) DYNAMICALLY AUGMENTING A BROADCAST STREAM OF A COMMON BROADCAST DEVICE

(71) Applicant: INTERNATIONAL BUSINESS MACHINES CORPORATION, ARMONK, NY (US)

(72) Inventors: Jason Malinowski, Pittstown, NJ (US); CHERANELLORE VASUDEVAN, Bastrop, TX (US); Swaminathan Balasubramanian, Troy, MI (US); Thomas G. Lawless, III, Wallkil, NY (US); Genevieve van den Boer, Richmond (CA)

(21) Appl. No.: 19/062,105

(22) Filed: Feb. 25, 2025

(51) Int. Cl. H04L 12/18; G06Q 30/0251; H04N 21/2668; H04N 21/45; H04N 21/466; H04W 4/021; H04W 24/02

(52) U.S. Cl. CPC H04L 12/18; G06Q 30/0251; G06Q 30/0254; G06Q 30/0257; G06Q 30/0258; G06Q 30/0261; G06Q 30/0269; H04N 21/2668; H04N 21/4532; H04N 21/4661; H04W 4/021; H04W 24/02; H04N 2201/3245

(57) ABSTRACT

An approach is provided for augmenting a broadcast stream while maintaining individual privacy. Transient user profiles of opted-in users within a proximity of a common broadcast device broadcasting a broadcast stream are collected. The transient user profiles are fed into a trained artificial intelligence model in communication with the one or more processors that outputs a recommended content tailored to a group of the opted-in users currently present in the proximity of the common broadcast device. The broadcast stream of the common broadcast device is augmented with the recommended content in response to the trained artificial intelligence model detecting a change to the group.

### BACKGROUND

The present invention relates to optimizing broadcast streams of common broadcast devices, and more particularly to augmenting the content of broadcast streams tailored to a group of users while maintaining individual privacy.

### SUMMARY

In one embodiment, the present invention provides a computer-implemented method. The method includes collecting transient user profiles of opted-in users within a proximity of a common broadcast device broadcasting a broadcast stream. The method further includes feeding the transient user profiles into a trained artificial intelligence model in communication with the one or more processors that outputs a recommended content tailored to groups of the opted-in users currently present in the proximity of the common broadcast device. The method further includes augmenting a broadcast stream of the common broadcast device with the recommended content in response to the trained artificial intelligence model detecting a change to the group.

A computer system and a computer program product corresponding to the above-summarized computer-implemented method are also described herein.

### BRIEF DESCRIPTION OF THE DRAWINGS

FIG. 1 is a block diagram of a system for augmenting a broadcast stream, in accordance with embodiments of the present invention.

FIG. 2 is a block diagram of modules included in code included in the system of FIG. 1, in accordance with embodiments of the present invention.

FIG. 3 depicts an environment having a common broadcast device broadcasting a broadcasting stream, in which opted-in users are present within proximity line, in accordance with embodiments of the present invention

FIG. 4 depicts a block diagram of a broadcast ecosystem, in accordance with embodiments of the present invention.

FIG. 5 depicts the environment having the common broadcast device broadcasting an augmented broadcast stream, in which a group of opted-in users present within proximity line has changed from a group shown in FIG. 3, in accordance with embodiments of the present invention.

FIG. 6 depicts a flowchart of a process of augmenting a broadcast stream, where operations of the flowchart are performed by modules in FIG. 2, in accordance with embodiments of the present invention.

FIG. 7 depicts a flow chart of a method for recommending content and providing time-splicing recommendations, in accordance with embodiments of the present invention.

FIG. 8 depicts a schematic diagram for controlling a movement of a common broadcast device, in accordance with embodiments of the present invention.

### DETAILED DESCRIPTION

### Overview

In brief overview, embodiments of the present invention is a dynamic collection of opted-in users (a collection of masked/transient profiles of opted-in users) at any point in time in front of a mass broadcast system, which fine tunes the program broadcast to best suit the dynamic collection of opted-in users. Masked personal profiles of opted-in users are collected, and a pre-trained artificial intelligence (AI) model is used to segment and recommend programs that is tailored to the dynamic collection of opted-in users. The streams being broadcast by the mass (or common) broadcast system is modified to broadcast the recommended programs tailored to the groups in a time sliced manner nearby the broadcast system or directly streaming augmented content to smart wearables or portable devices, without requiring that a user provide the user’s identity. Personal privacy is protected while also using a group of user’s interests to recommend content that the matches the interests of the users watching. As the group dynamic changes, embodiments of the present inventio detects the change and updates the recommended content along with the changing group dynamics.

The augmented broadcast stream is supplemented with augmented reality (AR) content to those with spatial computing devices (i.e. AR devices). The reality of those users is augmented with different forms of AR content and for various purposes to create a more engaging advertising experience to increase audience viewership of the core content and not detract from the core content. One purpose of the AR content can be informational.

Accordingly, embodiments of the present invention include transient profiles which protect privacy by requiring the user to divulge minimal personal information as the transient user profiles are created through zero-knowledge proofs. The transient user profiles are grouped into optimal categories for information exchange (advertisements, public service alerts, information exchange, preference for games, music, news, etc), and as the groups dynamically change over time, with each sampling of the group, new content is recommended for broadcasting by the common broadcasting device. In some cases, the transient user profile travels with the individual/group as they move between the ranges of nearest broadcast devices. AI clustering produces ranges of content for the main broadcast stream as well as AR content relevant to the broadcast stream. As a result of the system and method disclosed herein, there will be improved captive audiences, more effective monetization of broadcast content, increased likelihood to convert information consumers into customers, and reduced service or help desk questions about process or lines in common areas. Technical improvements are made with respect to automatically controlling content broadcast on common broadcast devices, AR integration for broadcast streams in public spaces, and physical control of the common broadcast device based on control signals sent to mechanical elements of the common broadcast device.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

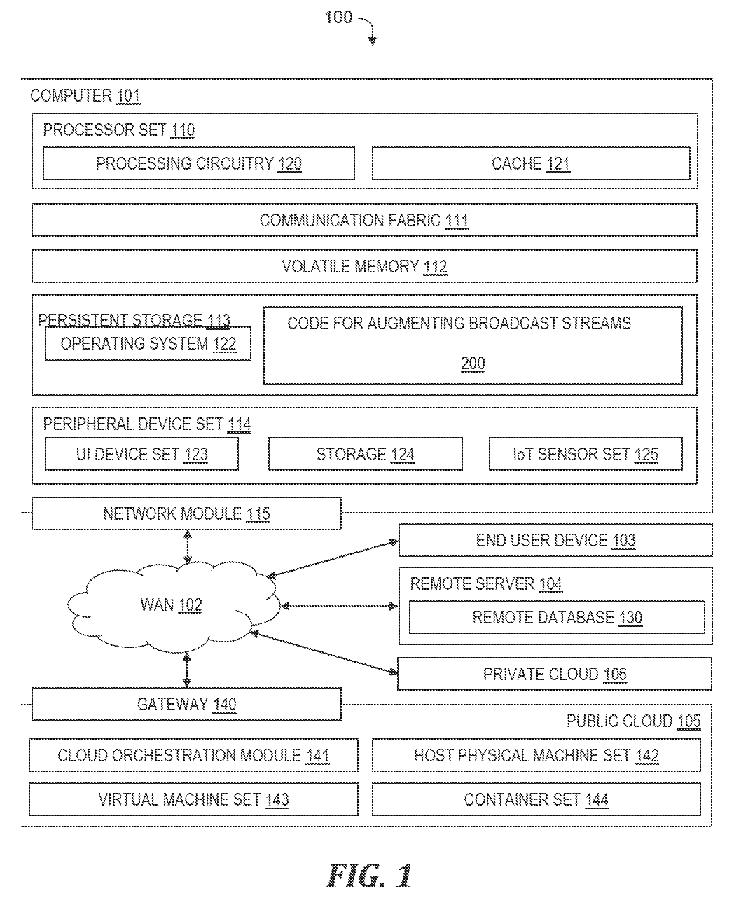

FIG. 1 is a block diagram of a system for augmenting broadcasting streams, in accordance with embodiments of the present invention. Computing environment 100 contains an example of an environment for the execution of at least some of the computer code involved in performing the inventive methods, such as code 200 for augmenting broadcasting streams. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Dynamically Augmenting a Broadcast Stream of a Common Broadcast Device

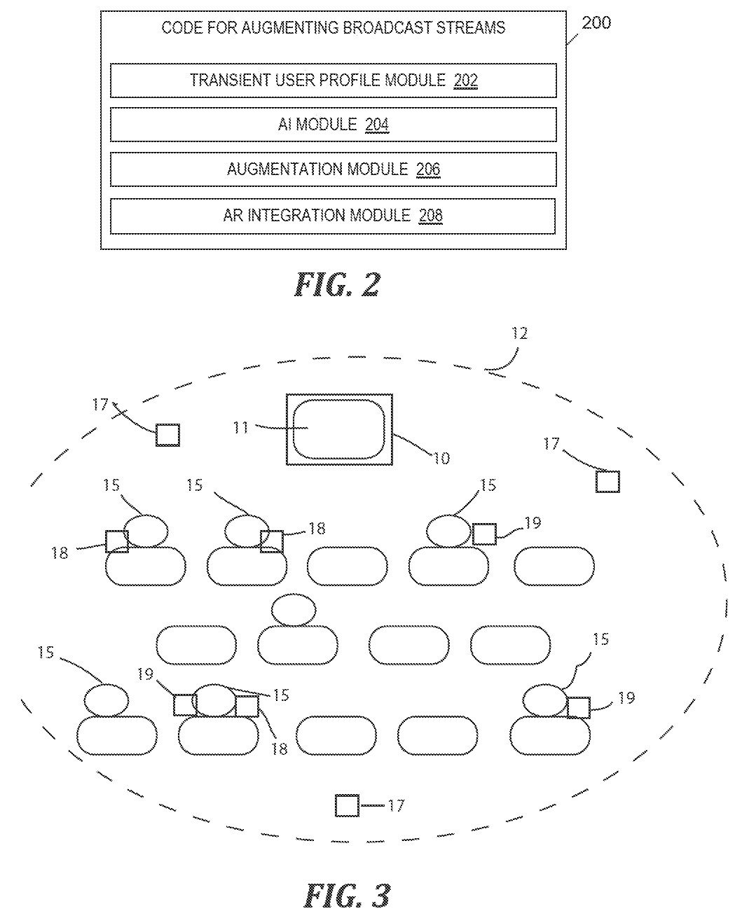

FIG. 2 is a block diagram of modules included in code included in the system of FIG. 1, in accordance with embodiments of the present invention. Code 200 includes a transient user profile module 202, an AI module 204, an augmentation module 206, and an AR integration module 208.

Transient user profile module 202 is configured to collect transient user profiles of opted-in users within a proximity of a common broadcast device 10 broadcasting a broadcast stream 11. Collecting the transient user profile may include establishing a new transient user profile in response to a user opting in, or receiving an already-created transient user profile from the user.

Transient user profiles are obtained through zero-knowledge proofs such that an identity of opted-in users are not known and personal information is anonymized. For instance, transient user profiles contain user-specific information and preferences without requiring a user to provide personal identifying information. Personal identifying information can include any information that can be used to distinguish or trace the identity of an individual, such as name, social security number, date and place of birth, mother's maiden name, or biometric records. Personal information can also include any other information that is linked or linkable to an individual, such as medical, educational, financial, and employment information.

In one embodiment, the transient user profile module 202 utilizes a transient identification program that reduces sharing of digital identification artifacts to a minimum required for creating the transient user profile. The transient identification program enables a user to control identification artifacts such that the user can share the artifacts selectively with trusted entities. In addition, the transient identification program aides a requesting entity with receiving the minimum required identification, as well as encouraging the entity to be selective with which identification artifacts the entity requests. In an embodiment, transient identification program includes a user interface that enables the user to input identification artifacts and associated preferences. Transient user profile module 202 receives a trigger of a situation that requires a user to share identification, for example, if the user opts-in to the receive content. The transient user profile module 202 receives a request for one or more identification artifacts from an identification requestor system, determines a set of artifacts, transmits the set of artifacts to the identification requestor system, and determines if identification requestor system approves the transmitted set of artifacts. If identification requestor system does not approve, then the transient user profile module 202 determines a new set of artifacts and transmits the new set of artifacts to identification requestor system . Responsive to receiving approval, transient user profile 202 generates a transient user profile for the opted-in user.

In other embodiments, the transient user profile of the opted-in user is already established and saved on the user’s mobile device. In this situation, the transient user profile module 202 receives the transient user profile from the user’s mobile device.

In addition to the identity of the opted-in user being protected, the opted-in user controls the amount of data to share as part of the transient user profile. The opted-in user may choose to share data regarding interests, likes, attributes, preferences, purchase history, hobbies, watch history, travel schedules, flight itineraries, calendars, and the like, and decline to share data regarding favorite foods, shops, and cities. The opted-in user can also share only some aspects of a category. For example, an opted-in user may want to share flight information to a destination but not hotel information where the opted-in user is staying when arriving at the destination. In another example, the opted-in user may want to share movie genres of interest but not the specific movie titles within that genre.

Examples of transient user profiles include: 1) individual aged 20-30 traveling to a sunny location in the southeast United States, beach within 25 miles, discount ticket, interested in comedy movies and cooking shows, calendar showing individual is attending a sporting event in the next month, 2) individual traveling with minor child to the Midwest United States, no beach within 100 miles, full price tickets, return trip less than 48 hours, 3) individual aged 40-50, traveling to Costa Rica, beach within 1 mile, ticket purchased via Costco Travel, vegan, likes hiking and watching historical documentaries. Transient user profiles can represent the information/entities a person may have at that time/day/event based on the context. The transient user profiles are transient because the same person may have different objectives and preferences on another time or situation, and also because the profiles may not remain in the pool of user profiles used to determine content. The transient user profiles can include stable profile characteristics like age, hobbies, food preferences, etc., and transient factors include time and destination of travel, type of travel, weather on that day, health conditions on that day, purpose of the trip, etc. The opted-in user may also change preferences for what is to be shared via the zero knowledge proof based on context feeling at a given day or time.

The transient user profile is designed to obtain the interests of the opted-in user while maintaining as much privacy as possible, including the identity of the opted-in user. The transient user profile module 202 collects the transient user profile of an opted-in user that comes within a proximity of the common broadcast device broadcasting the broadcast stream. FIG. 3 depicts an environment having a common broadcast device 10 broadcasting a broadcasting stream 11, in which opted-in users 15 are present within proximity line 12, in accordance with embodiments of the present invention. The common broadcast device 10 is a device capable of broadcasting, displaying, streaming, projecting, or otherwise playing media content that is shared amongst multiple people. The common broadcast device 10 is typically located in crowded areas, areas where groups of people are waiting, public spaces, private business spaces, and the like. Examples of a common broadcast device 10 is a television at a gate of an airport, a television in a waiting line at an amusement park, billboards, movie theater screens, traffic signs, digital advertisements, and the like. The common broadcast device 10 broadcasts a broadcast stream 11, which is content comprised of one or more programs for consumption by the people within the proximity line 12 of the common broadcast device 10. The proximity line 12 can be a predetermined distance or radius from the common broadcast device 10 or can be a designated room of an environment. The proximity line 12 can vary depending on the environment and the common broadcast device 10. The transient user profile module 202 collects the transient user profiles from the opted-in users 15 within the proximity line 12.

Referring back to FIG. 2, AI module 204 is configured to feed transient user profiles into a trained artificial intelligence model that outputs a recommended content tailored to a group of the opted-in users currently present in the proximity of the common broadcast device. In one embodiment, the transient user profiles are input into the trained AI model by the AI module 204 as the transient user profiles are collected by the transient user profile module 202. In other embodiments, the transient user profiles are input into the trained AI model by the AI module 204 periodically (e.g. after an interval of time). In yet another embodiment, the transient user profiles are input into the trained AI model by the AI module 204 after a predetermined number of new transient user profiles are collected by the transient user profile module 202 and/or after a predetermined number of opted-in users 15 have left the proximity to the common broadcast device, potentially changing the recommend content output by the trained AI model.

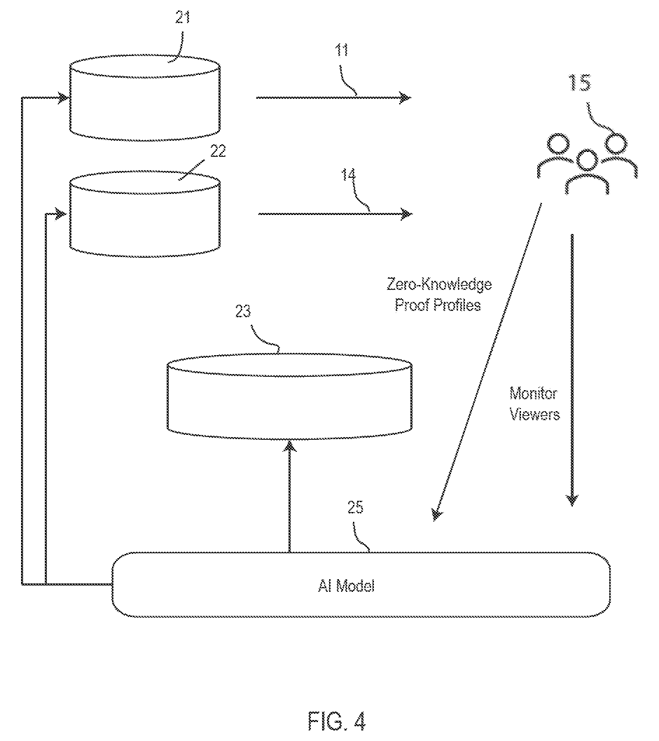

FIG. 4 depicts a block diagram of a broadcast ecosystem, in accordance with embodiments of the present invention. As illustrated in FIG. 4, the transient user profiles of the opted-in users 15 are fed to the AI model 25. The AI model 25, using the transient user profiles, recommends content stored in content library 21 for broadcasting as the broadcast stream 11. The content library 21 contains multi-media content and can be comprised of one or several libraries. The recommended content includes one or more programs that the AI model 15 predicts that the opted-in users in proximity to the common broadcast device 10 will be interested in and/or more likely to pay attention to the broadcast stream 11. The one or more programs of the recommended content includes any multi-media content such as videos, advertisements, shows, infomercials, programs, shorts, weather updates, news updates, movies, television shows, local events, tourism information, local business information, commercials, live events, pre-recorded live events, music videos, and the like.

The pre-trained AI model 25 outputs the recommended content by identifying a bucket of a plurality of buckets that each opted-in user belongs to by matching the transient user profiles with known profiles of the buckets stored in database 22. The transient user profiles are segmented into the plurality of buckets according to the matching. A group density is computed by clustering the transient user profiles of the group present within the proximity to the common broadcast device. Based on the group density, content is selected from at least one program library 21 that matches content commonly preferred by the group of opted-in users.

In some embodiments, the AI model 25 outputs a time-splicing recommendation for the recommended content tailored to the group of opted-in users. The AI model 25 may leverage the historical optimization profiles stored in database 23 to recommend the time-splicing information. The time-splicing recommendation can prioritize programs of the selected content. For instance, the recommended content may be a series of short videos relating to recreational sports, and the AI model 25 suggests a sequence or order of the short videos. The time-splicing recommendation can recommend a time period (e.g. an amount of time) to allocate to each program for broadcast as the broadcast stream 11. For example, the AI model 25 recommends that each short video relating to recreational sports should be played for 3 minutes and then an advertisement should be broadcast before moving on to the next short video, and a sequence of the programs that should be broadcast when each time period expires. The pre-trained AI model 25 updates the time-splicing recommendation in response to detecting changes to the group, as will be described in greater detail infra.

In some embodiments, the AI module 204 may leverage the AI model 25 to generate library content to be stored in the content library 21. As an example, the AI model 25 can generate folders containing packaged sequences of content that match specific groups of opted-in users. The output of the AI model 25 recommending content for a specific group of opted-in users may be saved to the historical database 23. The AI model 25 may use the recommended content as training to generate content similar to the content stored in library 21. The AI-generated content may then be stored in the library 21 and/or streamed directly to the common broadcast device 10.

In some embodiments, the AI module 204 is configured to filter the transient user profiles based on the interest level of the opted-in user. The filtering of the transient user profiles may be done prior to feeding a batch of transient user profiles to the AI model 25, or may be continuously performed and new streams of filtered transient user profiles may be continuously fed to the AI model 25. The AI modules 204 determines an interest level of the opted-in users using data received from one or more devices located within an environment of the common broadcast device and data received from mobile devices of the opted-in users. Referring back to FIG. 3, one or more devices 17 for capturing digital images/video of opted-in users 15 are positioned within the proximity line 12 to assess whether the opted-in user 15 is paying attention. In one embodiment, the devices 17 are cameras that capture a digital feed that is analyzed with a gaze tracking software to determine if the opted-in users 15 eyes are paying attention to the broadcast stream 11. In another embodiment, augmented reality device (AR devices) 19 associated with opted-in users 15 send coordinates of opted-in users 15 that are paying attention to the broadcast stream 11. To enhance the accuracy and/or assist the determining whether the opted-in user 15 is paying attention, mobile devices 18 associated with the opted-in users 15 send indicators that the opted-in users 15 are paying attention. As an example, the mobile device 18 sends a notification that the opted-in user 15 is searching for content related to the broadcast stream 11. The AI module 204 may assess the data from the devices 17 and/or the data from the mobile devices 18 and/or the data from the AR devices 19 to determine whether an opted-in user 15 is paying attention (e.g. is interested in) the broadcast stream 11. If it is determined that an opted-in user is not paying attention, the AI module 204 removes the transient user profile from the plurality of transient user profiles that are input into the AI module 25. The filtered transient user profiles with the transient user profiles of opted-in user’s not paying attention to the broadcast stream removed are fed to the AI model 25. As a result of the filtering, the content recommended by the AI model is improved for the opted-in user’s paying attention as the content is further tailored to a smaller group, and the likelihood of engagement of the opted-in users 15 with broadcast stream 11 is increased.

Referring again to FIG. 2, the augmentation module 206 augments the broadcast stream of the common broadcast device with the recommended content output by the AI model 25. At a given point in time, the common broadcast device 10 is broadcasting or otherwise displaying a broadcast stream 11 with content. In an effort to broadcast content that is more likely to engage viewers and/or benefit viewers in proximity to the common broadcast device 10, the augmentation module 206 augments, changes, replaces, and/or otherwise modifies the current broadcast stream 11 with recommended content output by AI model 25 that is tailored to a group of users (e.g. opted-in users 15) present within proximity to the common broadcast device 10. The transient user profiles of the group is collected, fed into the AI model 25 to determine recommended content for the group, and the augmentation module 206 augments the broadcast stream 11 with the recommended content tailored for the group present within proximity to the common broadcast device 10. The common broadcast device 10 broadcasts the recommended content and applies any time-splicing instructions provided with the recommendation output by the AI module 25.

In one embodiment, the augmentation module 206 retrieves the recommended content from the content library 21 and transmits the retrieved content to the common broadcast device 10 with instructions to augment the broadcast stream 11 to play the recommended content.

In one embodiment, the augmentation module 206 retrieves the recommended content from the content library 21 and transmits the retrieved content to a service provider that services the common broadcast device 10, with instructions to augment the broadcast stream 11 to play the recommended content.

As the common broadcast device 10 may be located in an environment where people are coming and going, the group of people present within proximity to the common broadcast device 10 dynamically changes. As the complexion of the group changes, the broadcast stream 11 is updated to account for the change to the group. The change to the group is detected by the trained AI model 25, which then outputs new recommended content based on a newly collected (or removed) transient user profiles, and the augmentation module 206 augments the broadcast stream 11 to broadcast or otherwise display the new recommended content.

The change to the group is a result of a movement of opted-in users into and out of the proximity to the common broadcast device 10, As a function of the movement of opted-in users, new transient user profiles of new opted-in users within the proximity of the common broadcast device 10 are collected and fed into the pre-trained AI model 25 which updates the recommend content. The newly collected transient user profiles, along with transient user profiles associated with opted-in users that are now outside of the proximity line 12, represents a new batch or collection of transient user profiles fed into the AI model 25, which can change the content recommended by the AI model 25. The augmentation module 206 replaces content of the current broadcast stream with the updated/new recommended content. The dynamically changing broadcast stream 11 enhances viewer engagement with the content being broadcast by the common broadcast device 10 because the broadcast stream 11 is dependent on the group of opted-in users currently present and watching the broadcast stream 11, without having to invade the privacy of the users due to use of transient user profiles obtained through zero-knowledge proofs.

In one embodiment, transient user profiles are continuously collected and fed to the AI module 25 for real-time content recommendation. For instance, as a new opted-in user crosses over the proximity line 12, the new user’s transient user profile is collected and input into the AI model 25, which may alter the previous output of the AI model 25 thus changing the content recommended as the broadcast stream 11 in real-time. The real-time change to the recommended content can mean that the broadcast stream 11 instantly changes the content on the screen, or the real-time change to the recommended content does not necessarily mean that the broadcast stream 11 instantly changes the content on the screen but that it may change at a break in content as suggested by the AI model 25 as part of the time-splicing recommendations. However, if most or all of the opted in users leave the proximity to the common broadcast device around the same time and then a new group takes the place of users leaving (e.g. airport gate when plane boards, replaced by people catching the next flight at the gate) the broadcast stream 11 could be changed in real-time as the recommended content changes as output by the AI model 25.

In an alternative embodiment, transient user profiles are periodically collected and fed to the AI module 25 for potentially updated content recommendation. For instance, as new opted-in users cross over the proximity line 12, the new users’ transient user profiles are collected and temporarily stored in a queue, and input into the AI model 25 at the next scheduled time for inputting into the AI model 25. The new batch of transient user profiles may alter the previous output of the AI model 25 thus changing the content recommended as the broadcast stream 11 periodically and/or according to time-splicing recommendations output by the AI model 25.

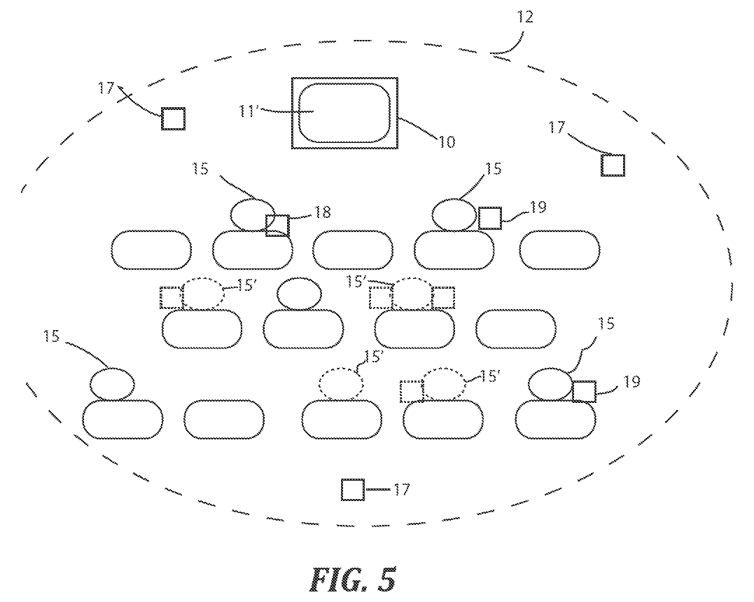

The augmenting of the broadcast stream 11 of the common broadcast device 10 with the recommended content in response to the trained AI model 25 detecting a change to the group is further described with respect to FIGS. 3 and 5. Six opted-in users 15 are depicted in seats within proximity to the common broadcast device 10. The transient user profiles of the six opted-in users have been collected, fed to the AI model 25, and the recommend content for these six opted-in users is the current broadcast stream 11. FIG. 5 depicts the environment having the common broadcast device 10 broadcasting an augmented broadcast stream 11, in which a group of opted-in users 15 present within proximity line 12 has changed from a group shown in FIG. 3, in accordance with embodiments of the present invention. As illustrated, two of the previous opted-in users 15 have left and four new opted-in users 15’ (shown in dashed lines) have crossed over the proximity line 12, thereby a change to the group has occurred and a new group is formed proximate the common broadcast device 10. The transient user profiles of the newly opted-in users 15’ are collected and analyzed by the AI model 25 together with the remaining four opted-in users 15. The AI model 25 detects a change to the group based on the newly collected transient user profiles being different than the previously collected transient user profiles and outputs updated recommended content that is tailored to the new group, resulting in the broadcast stream 11 being augmented to now broadcast the updated content as broadcast stream 11’.

The augmentation module 206 is further configured to provide supplemental content and/or notifications to mobile devices 18 of opted-in users 15. If the opted-in users 15 have opted-in to receive communications to their mobile devices 18, the augmentation module 206 may send content relevant to the broadcast stream 11 to the opted-in users’ mobile devices 18. For instance, if the broadcast stream 11 is a baseball game, the augmentation module 206 can send a link to one or more of the opted-in users’ mobile device 18 regarding purchasing tickets to a baseball game. The supplemental content provided by the augmentation module 206 may be individualized to each opted-in user based on the interests known from the transient user profile, or may be sent to the group based on the interests of the group known from the collective transient user profiles. The augmentation module 206 may also send notifications to the opted-in users 15. The notifications may include flight changes, safety announcements, weather information, news updates, and the like.

The augmentation module 206 may turn the common broadcast system 10 into a public announcement device that can deliver updates or announcements that may be helpful for the opted-in users 15. For example, it is known from the transient user profiles that seven of the nine opted-in users are traveling to a destination from a gate at an airport. The broadcast stream 11 can be interrupted to display or otherwise announce the gate change to the opted-in users in proximity within the common broadcast device 10.

The broadcast stream 11 can also include augmented reality integration. The AR module 208 for AR integration is configured to integrate AR into the broadcast stream 11 and/or provide AR content from AR content library 22 to supplement the broadcasting of broadcast stream 11. The AR module 208 transmits a request to augmented reality devices 19 of the opted-in users 15 to connect over a network with the common broadcast device 10 and/or computer 101. In response to receiving a response granting the request from a augmented reality device 19 of an opted-in user 15, the AR module 208 sends augmented reality content over the network to the augmented reality device 19. The AR content can vary across opted-in users, and the AR content provided to the AR devices 19 of the opted-in users 15 augment the reality of the opted-in users. The AR content can relate to the recommended content being broadcast by the common broadcast device. The AR content can be personalized only to the opted-in user and not a group of users. The AR content can be unrelated to the recommended content being broadcast by the common broadcast device. The AR content can also be simultaneously shared with other augmented reality devices of other opted-in users within the environment.

Examples of AR content include digital link to supplementary content, information banners in a video content, a picture-in-picture video/imagery, additional video content, sensory content including scents emitted to supplement the broadcast stream for enabled devices, a notification about travel plans, flight plan updates, news updates, targeted advertisements, public service announcements, and weather information, and the like.

The AR integration performed the AR module 208 can encompass experiential artifacts offered that expand upon and enhance the core programming content (of the broadcast stream 11) in traditional form (e.g. video). The AR content can be in different forms and for various purposes to create a more engaging advertising experience to increase audience viewership of the core content and not detract from the core content. One purpose of the AR content can be informational such as a warning about a significant weather event, major transportation disruptions and construction or local holidays at a travel destination, educational information, resource conservation and recycling mandates, or advertising such as advertisements for complementary services or products. From each given clip of core programming video, there can be a deviation which still makes sense in the context. For example, if showing an image of animals, there can be AR content for topics about travel, animal biology, or an advertisement for zoo tickets.

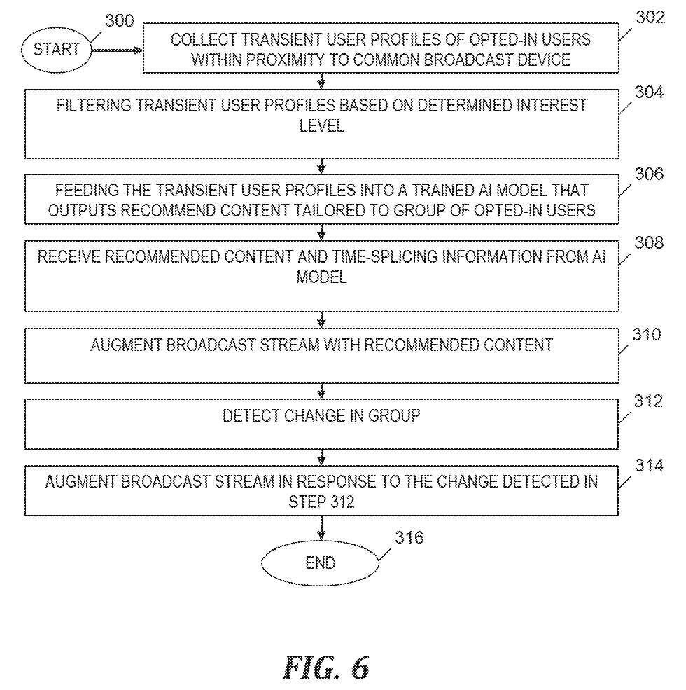

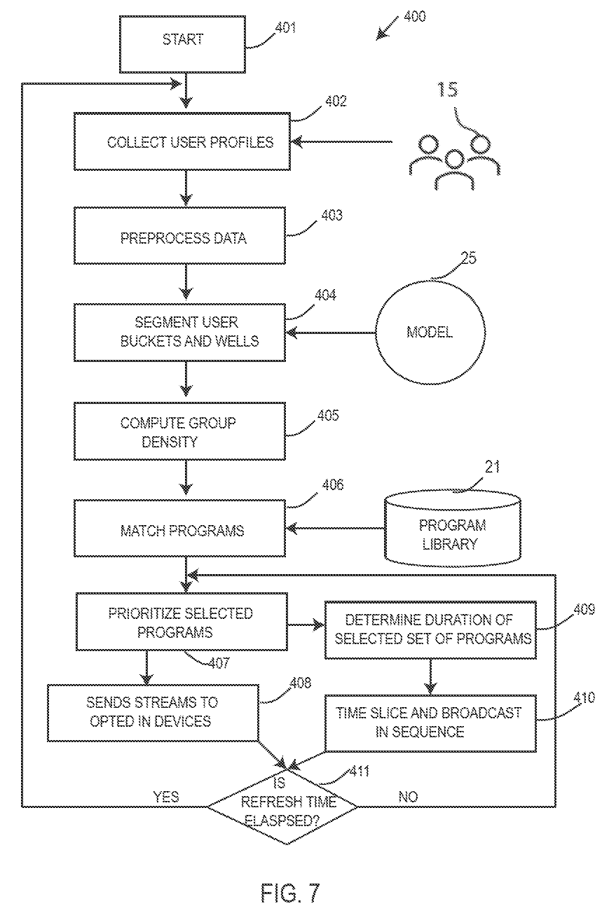

The functionality of the modules included in code 200 is described in more detail in the discussions presented below relative to FIG. 6 and FIG. 7.

FIG. 6 is a flowchart of a process of augmenting a broadcast stream, where operations of the flowchart are performed by modules in FIG. 2, in accordance with embodiments of the present invention. The process of FIG. 6 begins at a start node 300. Content is being broadcast by a common broadcast device.

In step 302, transient user profiles of opted-in users within a proximity to the common broadcast device are collected.

In step 304, the collected transient user profiles are filtered based on a determined level of interest of the opted-in users.

In step 306, the transient user profiles are input into a trained AI model that outputs recommended content tailored to a group of opted-in users.

In step 308, the recommended content is received along with time-splicing information from the AI model.

In step 310, the broadcast stream is augmented with the recommended content.

In step 312, a change to the group is detected.

In step 314, the broadcast stream is again augmented with updated recommended content, in response to the detection.

The process is ended at step 316.

As a result of the process of augmenting a broadcast stream, the computer system that includes modules 202, 204, 206, and 208 optimizes content selection based on user’s interest while maintaining the privacy of the users due to the transient user profiles that mask an identity of the user. Additionally, the computer system that includes modules 202, 204, 206, and 208 dynamically adjusts to movement of opted-in users to deliver relevant broadcasts that enhance user experience and increase engagement with the content being displayed as a function of the methods disclosed herein. Further, the computer system that includes modules 202, 204, 206, and 208 integrates the augmented broadcast stream with AR content via AR devices worn by the opted-in users so that an environment of the user is augmented with tailored content.

FIG. 7 depicts a flow chart of a method 400 for recommending content and providing time-splicing recommendations, in accordance with embodiments of the present invention. The process is started at step 401.

In step 402, transient user profiles are collected.

In step 403, the collected transient user profiles are depersonalized by preprocessing the data submitted with the transient user profiles.

In step 404, AI model 25 segments the user buckets and wells using the transient user profiles.

In step 405, a group density is computed.

In step 406, the recommended content from the AI model 25 is matched with programs stored in content library 21.

In step 407, the programs retrieved from the content library 21 are prioritized.

In step 408, streams are sent to mobile devices of opted-in users.

In step 409, a duration of the selected set of programs is determined.

In step 410, the programs are broadcasted in sequence according to step 409.

In step 411, it is determined whether a refresh time has elapsed. If yes, the process returns to step 402. If not, the process returns to step 407.

### Controlling a Movement of the Common Broadcast Device Based on Interest Level and AI Output

As described supra, embodiments of the present invention augment a broadcast stream of a common broadcast device using masked user profiles so that content being broadcast can be relevant and improve engagement of the viewers with the broadcasted content. In further embodiments of the present invention, the common broadcast device can be physically controlled/moved to face a direction with a higher concentration of interested, opted-in users.

Embodiments of the present invention can determine an interest level of opted-in users using data received from one or more devices located within an environment of the common broadcast device and data received from mobile devices of the opted-in users, as described above. The data from the environmental devices and/or the data from the mobile devices and/or the data from the AR devices to determine whether an opted-in user 15 is paying attention (e.g. is interested in) can also be used to locate where the highest concentration of interested, opted-in users are located. If it is determined that the common broadcast device is facing a direction with none or only a few interested users, the computer 101 can send a control signal to a controller and/or actuator of the common broadcast device to rotate or otherwise move the common broadcast device to face a direction having a higher concentration of interested users. As a result of controlling the common broadcast device using one or more control signals, the content recommended by the AI model reaches more interested users, and the likelihood of engagement is increased.

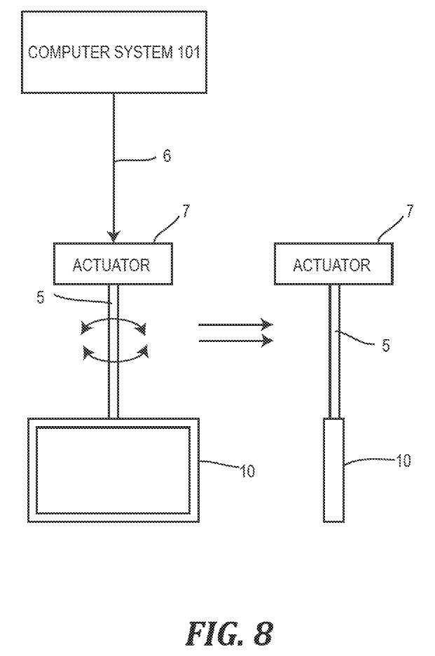

FIG. 8 depicts a schematic diagram for controlling a movement of a common broadcast device, in accordance with embodiments of the present invention. The common broadcast device 10 is coupled to the computer system 101, for example, over a network. The common broadcast device 10 includes an actuator 7 capable of rotating a mechanical element 5 connected to the display of the common broadcast device 10. The actuator 7 can be a controller, a motor, an actuator, and the like, capable of receiving control signals from computer system 101 and causing rotation or movement of the shaft 5 and/or display of the common broadcast device 10. The mechanical element 5 may be a shaft, a television mount, a plurality of frame members, a rod, or similar mechanical structure that is capable of fixing, mounting, or otherwise securing the broadcast device to a structure, such as a ceiling, a wall, and the like.

In the initial state (left side of FIG. 8), the common broadcast device 10 faces a first direction. As an example, the common broadcast device 10 faces a first section of seats in an environment. If the computer system 101, in accordance with the disclosures herein, determines that a higher concentration of interested opted-in users are seated nearby the common broadcast device but are unable to see or conveniently see the display of the common broadcast device, the computer system 101 controls the common broadcast device 10 to move so that the common broadcast device 10 faces another direction that accommodates the higher concentration of interested opted-in users. In one embodiment, the computer system 101 generates and sends a control signal 6 to the actuator 7 to cause physical movement (e.g. rotation of mechanical element 5 connected to display) of the common broadcast device 10. In the moved state (right side of FIG. 8), the common broadcast faces a second direction, which is different than the first direction. As an example, the common broadcast device 10 faces a second section of seats to the side of the first section of seats in an environment.

### Traning the AI Model to Recommend Content Based on Transient User Profiles

The AI model 25 is trained to recognize clusters of opted-in users who have common interests based on transient user profiles. The AI model 25 can be trained in different ways. An exemplary set of steps of train the AI model 25 include collecting historical data regarding a large cross-section of opted-in users, such as but not limited to personal attributes, age, profession, personal interests: sports, music, books, movies, education, dietary preferences, social connections, items purchased frequently, and the like. The above data is correlated with actions of the person, such as programs watched mostly – sports, movies, soap operas, interviews, types of sports shows, types of movies, types of places visited, types of restaurants visited, and the like. Buckets of users are created with common attributes and common behaviors. Standard clustering algorithms like k-means clustering, affinity propagation clustering algorithm, or ordering points to identify the clustering structure algorithm can be used. The buckets represent a set of attributes and preferred program, places, types of movies/shows. The buckets of users are further organized into common wells to find similarity / affinity using next level of clustering. The types of programs are now ordered based on most commonly preferred ones, including augmented reality content.

### Examples

### Example 1

### Environment: Airport Gate

Application: A television at the airport gate conventionally broadcasts content selected by the service provider of the television, such as world news and weather and occasional sports scores and highlights, and runs on a loop or at least does not change relative to the people sitting nearby the television. Passengers wait by the airport gate until a boarding process begins, and a new group of passengers fill those seats. A certain number of passengers do not pay any attention to the television, while some passengers pass the time by watching the television. The system and method disclosed herein would broadcast content tailored for the people, if opted in, that are paying attention to the television. As people left and new people occupied the seats near the television, the television content would be changed to reflect content that the new group of people paying attention would be interested in. None of the passengers would have to provide their identity to the system for the television content to be changed accordingly.

### Example 2

### Environment: Amusement Park Ride Line

Application: Multiple televisions are often positioned throughout the lines for an amusement park ride. The televisions typically all play the same content on a loop, no matter who is proximate those televisions. As the line moves, new groups of people become proximate to those televisions. Instead of playing the same content on all televisions, the system and method disclosed herein would change the broadcast content to be tailored for the group of people closest to the televisions. None of the amusement park guests would have to provide their identity to the system for the television content to be changed accordingly.

### Example 3

### Environment: Stop and Go Traffic

Application: Digital advertisements using a display connected to a network could be dynamically updated based on the people in the cars proximate the digital advertisement.

### Example 4

### Environment: Movie Theater

Application: A movie theater projection screen and projector is considered a common broadcast, as multiple people view the same screen to consume content. While the system and method disclosed herein would not alter the core programming content, which is the feature film, AR content could be delivered to opted-in users wearing spatial computing device. The AR content could personalize the main screen projection using augmented reality, or deliver supplemental content related to the movie for personal viewing using the user’s spatial computing device.

The descriptions of the various embodiments of the present invention have been presented herein for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
collecting, by one or more processors, transient user profiles of opted-in users within a proximity of a common broadcast device broadcasting a broadcast stream;
feeding, by the one or more processors, the transient user profiles into a trained artificial intelligence model in communication with the one or more processors that outputs a recommended content tailored to a group of the opted-in users currently present in the proximity of the common broadcast device; and
augmenting, by the one or more processors, the broadcast stream of the common broadcast device with the recommended content in response to the trained artificial intelligence model detecting a change to the group.

2. The method according to claim 1, wherein the change to the group is a result of a movement of opted-in users into and out of the proximity to the common broadcast device, and as a function of the movement of opted-in users, new transient user profiles of new opted-in users within the proximity of the common broadcast device are collected and fed into the pre-trained artificial intelligence model which updates the recommend content.

3. The method of claim 1, further comprising:
determining, by the one or more processors, an interest level of the opted in users using data received from one or more devices located within the proximity of the common broadcast device and data received from mobile devices of the opted-in users; and
filtering, by the one or more processors, the transient user profiles based on the interest level prior to feeding the pre-trained artificial intelligence model.

4. The method of claim 1, wherein the transient user profiles are obtained through zero-knowledge proofs such that an identity of the opted-in users are not known and personal information is anonymized.

5. The method of claim 1, further comprising:
transmitting, by the one or more processors, a request to augmented reality devices of the opted-in users to connect over a network with the common broadcast device; and
in response to receiving a response granting the request from an augmented reality device of an opted-in user, sending augmented reality content over the network to the augmented reality device that: i) relates to the recommended content being broadcast by the common broadcast device, ii) is personalized only to the opted-in user and not a group of users, iii) is unrelated to the recommended content being broadcast by the common broadcast device, and/or iv) is simultaneously shared with other augmented reality devices of other opted-in users within the proximity to the common broadcast.

6. The method of claim 5, wherein the augmented reality content includes digital link to supplementary content, information banners in a video content, a picture-in-picture video/imagery, additional video content, sensory content including scents emitted to supplement the broadcast stream for enabled devices, a notification about travel plans, flight plan updates, news updates, targeted advertisements, public service announcements, and weather information.

7. The method of claim 1, wherein the pre-trained artificial intelligence model outputs the recommended content by:
identifying a bucket of a plurality of buckets that each opted-in user belongs to by matching the transient user profiles with known profiles of the buckets;
segmenting the transient user profiles into the plurality of buckets according to the matching;
computing a group density by clustering the transient user profiles of the group present within the proximity to the common broadcast device; and
selecting, based on the group density, multiple types of content from at least one program library that matches content commonly preferred by the group of opted-in users.

8. The method of claim 1, wherein the pre-trained artificial intelligence model outputs a time-splicing recommendation for the recommended content tailored to the group of opted-in users, the time-splicing recommendation including a prioritization of programs, a time period that each program should be broadcast, and a sequence of the programs that should be broadcast when each time period expires;
wherein the pre-trained artificial intelligence model updates the time-splicing recommendation in response to detecting the change to the group.

9. A computer system comprising:
a processor set;
one or more computer-readable storage media; and
program instructions stored on the one or more computer-readable storage media to cause the processor set to perform operations comprising:
collecting, by one or more processors, transient user profiles of opted-in users within a proximity of a common broadcast device broadcasting a broadcast stream;
feeding, by the one or more processors, the transient user profiles into a trained artificial intelligence model in communication with the one or more processors that outputs a recommended content tailored to a group of the opted-in users currently present in the proximity of the common broadcast device; and
augmenting, by the one or more processors, the broadcast stream of the common broadcast device with the recommended content in response to the trained artificial intelligence model detecting a change to the group.

10. The computer system of claim 9, wherein the change to the group is a result of a movement of opted-in users into and out of the proximity to the common broadcast device, and as a function of the movement of opted-in users, new transient user profiles of new opted-in users within the proximity of the common broadcast device are collected and fed into the pre-trained artificial intelligence model which updates the recommend content.

11. The computer system of claim 9, further comprising:
determining, by the one or more processors, an interest level of the opted in users using data received from one or more devices located within the proximity to the common broadcast device and data received from mobile devices of the opted-in users; and
filtering, by the one or more processors, the transient user profiles based on the interest level prior to feeding the pre-trained artificial intelligence model.

12. The computer system of claim 9, wherein the transient user profiles are obtained through zero-knowledge proofs such that an identity of the opted-in users are not known and personal information is anonymized.

13. The computer system of claim 9, further comprising:
transmitting, by the one or more processors, a request to augmented reality devices of the opted-in users to connect over a network with the common broadcast device; and
in response to receiving a response granting the request from a augmented reality device of an opted-in user, sending augmented reality content over the network to the augmented reality device that: i) relates to the recommended content being broadcast by the common broadcast device, ii) is personalized only to the opted-in user and not a group of users, iii) is unrelated to the recommended content being broadcast by the common broadcast device, and/or iv) is simultaneously shared with other augmented reality devices of other opted-in users within the proximity to the common broadcast.

14. The computer system of claim 13, wherein the augmented reality content includes digital link to supplementary content, information banners in a video content, a picture-in-picture video/imagery, additional video content, sensory content including scents emitted to supplement the broadcast stream for enabled devices, a notification about travel plans, flight plan updates, news updates, targeted advertisements, public service announcements, and weather information.

15. The computer system of claim 9, wherein the pre-trained artificial intelligence model outputs the recommended content by:
identifying a bucket of a plurality of buckets that each opted-in user belongs to by matching the transient user profiles with known profiles of the buckets;
segmenting the transient user profiles into the plurality of buckets according to the matching;
computing a group density by clustering the transient user profiles of the group present within the proximity to the common broadcast device; and
selecting, based on the group density, content from at least one program library that matches content commonly preferred by the group of opted-in users.

16. The computer system of claim 9, wherein the pre-trained artificial intelligence model outputs a time-splicing recommendation for the recommended content tailored to the group of opted-in users, the time-splicing recommendation including a prioritization of programs, a time period that each program should be broadcast, and a sequence of the programs that should be broadcast when each time period expires;
wherein the pre-trained artificial intelligence model updates the time-splicing recommendation in response to detecting the change to the group.

17. A computer program product comprising:
one or more computer-readable storage media; and
program instructions stored on the one or more computer-readable storage media to perform operations comprising:
collecting, by one or more processors, transient user profiles of opted-in users within a proximity of a common broadcast device broadcasting a broadcast stream;
feeding, by the one or more processors, the transient user profiles into a trained artificial intelligence model in communication with the one or more processors that outputs a recommended content tailored to a group of the opted-in users currently present in the proximity of the common broadcast device; and
augmenting, by the one or more processors, the broadcast stream of the common broadcast device with the recommended content in response to the trained artificial intelligence model detecting a change to the group.

18. The computer program product of claim 17, wherein the change to the group is a result of a movement of opted-in users into and out of the proximity to the common broadcast device, and as a function of the movement of opted-in users, new transient user profiles of new opted-in users within the proximity of the common broadcast device are collected and fed into the pre-trained artificial intelligence model which updates the recommend content.

19. The computer program product of claim 17, further comprising:
transmitting, by the one or more processors, a request to augmented reality devices of the opted-in users to connect over a network with the common broadcast device; and
in response to receiving a response granting the request from a augmented reality device of an opted-in user, sending augmented reality content over the network to the augmented reality device that: i) relates to the recommended content being broadcast by the common broadcast device, ii) is personalized only to the opted-in user and not a group of users, iii) is unrelated to the recommended content being broadcast by the common broadcast device, and/or iv) is simultaneously shared with other augmented reality devices of other opted-in users within the proximity to the common broadcast.

20. The computer program product of claim 17, wherein the pre-trained artificial intelligence model outputs the recommended content by:
identifying a bucket of a plurality of buckets that each opted-in user belongs to by matching the transient user profiles with known profiles of the buckets;
segmenting the transient user profiles into the plurality of buckets according to the matching;
computing a group density by clustering the transient user profiles of the group present within the proximity to the common broadcast device; and
selecting, based on the group density, content from at least one program library that matches content commonly preferred by the group of opted-in users’
wherein the pre-trained artificial intelligence model outputs a time-splicing recommendation for the recommended content tailored to the group of opted-in users, the time-splicing recommendation including a prioritization of programs, a time period that each program should be broadcast, and a sequence of the programs that should be broadcast when each time period expires;
wherein the pre-trained artificial intelligence model updates the time-splicing recommendation in response to detecting the change to the group.
